(19) United States
(12) Patent Application Publication
(10) Pub. No.: US 2024/0211898 A1
(43) Pub. Date: Jun. 27, 2024

(54) AUTONOMOUS KNOWLEDGE-BASED SMART WASTE COLLECTION SYSTEM

(71) Applicant: University of Sharjah, Sharjah (AE)

(72) Inventor: Mohamed ABDALLAH, Sharjah (AE)

(21) Appl. No.: 18/089,098

(22) Filed: Dec. 27, 2022

(51) Int. Cl. G06Q 10/30; G01C 21/34; G06Q 10/04

(52) U.S. Cl. CPC G06Q 10/30; G01C 21/343; G01C 21/3492; G06Q 10/04

(57) ABSTRACT

The present invention relates to a smart knowledge-based waste collection system and method for monitoring and collecting waste of an area by optimizing a dynamic waste collection route by analyzing actual and historical waste generation data of the waste bin to forecast volume of daily waste generated, prioritizing the waste bin to be serviced if a volume of daily waste of the waste bin predicted is larger than bin capacity, assigning waste bin and real-time traffic data to the route optimization module to compute the dynamic waste collection route and transmitting the optimized route to the autonomous vehicle to collect the waste from the waste bins to be serviced.

### FIELD OF THE INVENTION

Embodiments of the present invention relate to the field of smart waste collection systems and more particularly to an autonomous knowledge-based smart waste collection system for monitoring and collecting solid waste by forecasting waste generation patterns and optimizing a waste collection route.

### BACKGROUND OF THE INVENTION

Human activity creates waste, wherein such waste needs to be removed from urban environments in order to avoid a disruption of orderly functioning of communities and municipalities. As the human population grows, existing resources are divided amongst more people, such that an increase in operating efficiency of municipal services is needed if a standard of living enjoyed by people is to be maintained in future.

Waste management is one of the major challenges faced by municipalities throughout the world due to its direct impacts on the environment and public health, as well as its economic burdens and extensive operations. The rapid growth in waste generation rates has led to more challenging management processes, particularly the collection system. The conventional waste collection (CWC) system includes a fleet of trucks transferring waste collected from bins to intermediate or ultimate disposal sites. However, typical CWC systems are inefficient resulting in unnecessary air pollution, traffic congestion, and financial losses. Moreover, the CWC system serves all bins with fixed routes regardless of the actual used capacity of bins. In many occasions, the waste bins are only partially full at the time of collection. Thus, to overcome such inefficient operation, smart collection systems are developed.

The waste collection companies face various challenges when collecting different types of solid wastes from various sites at different locations for example:
(i) planning and scheduling routes for waste haulers to employ for ensuring maximum waste collection;
(ii) avoiding penalties, for example fines from municipal authorities, for delayed collection of waste, for example where waste overflows from waste containers and potentially represents a safety and/or health hazard;
(iii) predicting customer waste generation patterns, for example based upon daily usage of waste containers, or during festivals, holidays, and weekends when increased customer consumption of resources, for example food and drinks products, occurs; and
(iv) saving resources, and hence money, and reducing environmental impact of waste collection processes, for example less fuel consumption in waste collection vehicles, using less waste collection equipment, and optimizing waste collection intervals.

With the advent of technology, the sensor-based smart waste collection (SWC) systems with bin sensors are developed to replace the conventional collection system with a sustainable solution by monitoring the actual amount of waste in the bins and optimizing the collection routes accordingly. However, there have not been any full-scale implementations of typical sensor-based SWC systems to date, mainly due to the lack of practicality and limited robustness of such a hardware-intensive framework. Moreover, the sensor-based SWC system is an expensive system consisting of various costly components and intricate wireless connections that require multiple modifications to the city infrastructure and increase maintenance costs.

Other disadvantages of sensor-equipped bins include the need for constant wireless communications between bins and control center, large number of waste bins to be monitored, costly maintenance of numerous scattered service points (waste bins), vulnerability and short lifetime of sensors due to direct contact with waste and continuous extreme weather conditions, less security of the installed sensors due to accessibility of public, and lack of protection against vandalism.

Therefore, there is a need to develop a new approach to overcome the shortcomings of the sensor-based SWC systems and develop a more robust, practical, simple, and cost-effective operation. Thus, the present invention focuses on an autonomous knowledge-based smart waste collection system for monitoring and optimizing the waste collection process, without the need for sensors in waste bins or extensive hardware components.

### SUMMARY OF THE INVENTION

Aspects of the disclosed embodiments seek to provide a smart knowledge-based waste collection system and a method thereof.

Embodiments of the present invention relates to a smart waste collection system for monitoring and collecting waste of an area by forecasting waste generation patterns and optimizing waste collection routes. The smart waste collection system includes a plurality of waste bins, one or more on-board truck sensors, an autonomous collection vehicle, a cloud server, and a communication network. In particular, the cloud server further includes a plurality of databases and a plurality of modules. Moreover, the smart waste collection system is an autonomous knowledge-based smart waste collection system.

In accordance with an embodiment of the present invention, the waste bins hold the waste of the area. And each of the plurality of waste bins is associated with a unique number and location.

In accordance with an embodiment of the present invention, one or more on-board truck sensors acquire historical waste generation data of the plurality of waste bins. The one or more on-board truck sensors may include weighing sensors, level sensors, LiDAR sensors, cameras, spatial positioning sensors, and a combination thereof.

The autonomous collection vehicle collects the waste from the plurality of waste bins therefrom selected by the smart waste collection system. The autonomous collection vehicle may be a GPS-navigated driverless collection truck or an autonomous electric mobile robot.

In accordance with an embodiment of the present invention, the cloud server receives one or more signals via a wireless communication network to forecast waste generation patterns for each of the plurality of waste bin and determine an optimized waste collection route to collect the waste from the prioritized waste bins. In particular, the cloud server includes a plurality of databases to store waste data for all the plurality of waste bins and a plurality of modules, characterized in that: a waste prediction module, a bin selection module, a route optimization module, and an autonomous navigation module.

The waste prediction module is operably configured to forecast the volume of daily waste generated by a prediction model for each of the plurality of waste bins. The prediction model may constitute different types of machine-learning algorithms, including but not limited to, classification, regression, neural networks, ensemble, or hybrid models, such as support vector machine, random forest, generalized linear model, and/or gradient boosted trees. Further, the waste prediction module analyzes the historical waste generation data, the actual waste generation data, and the local parameters to forecast daily waste of each waste bin.

The bin selection module is configured to prioritize and select one or more waste bin from the plurality of waste bins to be serviced for collecting waste by a bin selection algorithm. In particular, the bin selection algorithm prioritizes the waste bin to be serviced based on the forecasted waste quantity and selects the waste bin to be serviced for collection when the predicted volume of waste stored in the waste bin is larger than the capacity of the waste bin.

In accordance with an embodiment of the present invention, the waste bin that has reached its full capacity with a safety margin is generally selected to collect its waste.

The route optimization module is configured to compute the optimized waste collection route for the waste bins to be serviced and transmit the optimized route thereof. Real-time traffic data may be used in the route optimization module to avoid road closures, traffic accidents, road works, traffic congestion, and/or rush hours. The route optimization module may constitute individual or hybrid models based on exact optimization algorithms, such as integer programming and/or Dijkstra, and/or metaheuristic optimization methods, such as genetic algorithm, simulated annealing, particle swarm, and/or ant colony. The route optimization module determines the optimized waste collection route that achieves minimum travel time, minimum trip distance, and/or maximum environmental and economic sustainability.

The autonomous navigation module is operably configured with the route optimization module to transmit the optimized collection route for the waste bins to be serviced to an autonomous collection vehicle.

In accordance with an embodiment of the present invention, the communication network allows communication between one or more on-board truck sensors, plurality of modules, plurality of databases, and the cloud server.

In a possible implementation form of the smart waste collection system, the cloud server is configured to analyze actual waste generation data, historical waste generation data, and local parameters for the plurality of waste bins to forecast the volume of daily waste generated in each of the plurality of waste bins, prioritize the waste bin from the plurality of waste bins to be serviced for collecting the waste, feed the waste bin to be serviced to the route optimization module for computing the optimized collection route for collecting waste, assign the waste bin to be serviced for collecting the waste to the autonomous vehicle, and transmit the optimized route with latitude and longitude coordinates of the waste bin. In particular, different collection routes are optimized depending on the waste bins to be serviced and the real-time traffic data of the road network.

In accordance with one or more embodiments of the present invention, the smart waste collection system is operably configured with smart transportation systems and/or various internet of things (IOT) systems in smart cities.

Another embodiment of the present invention relates to a method for monitoring and collecting waste from one or more waste bins of an area by optimizing waste collection routes. The method includes steps of collecting actual and historical waste generation data of the plurality of waste bins, analyzing the actual and historical waste generation data and local parameters for the plurality of waste bins to forecast a volume of daily waste generated in each of the plurality of waste bins, determining whether a predicted volume of daily waste of the waste bin exceeds the capacity of the waste bin, prioritizing the waste bin from the plurality of waste bins to be serviced for collecting the waste, assigning the waste bin to be serviced to a route optimization module, computing an optimized route with latitude and longitude coordinates of the waste bin to be serviced, and transmitting the optimized route to the autonomous vehicle to collect the waste from the bins to be serviced.

In accordance with an embodiment of the present invention, the historical waste generation data includes bins location, waste collection route, volume of daily waste collected, and alike data for each of the plurality of waste bins.

In accordance with an embodiment of the present invention, local parameters may include types of households, demographic statistics, seasonal calendar, and/or other local data affecting waste generation patterns.

Additional aspects of the invention will be set forth in part in the description which follows, and in pert will be obvious from the description, or may be learned by practice of the invention.

### BRIEF DESCRIPTION OF THE DRAWINGS

So that the manner in which the above-recited features of the present invention is understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1A is a block diagram illustrating an exemplary smart knowledge-based waste collection system within which various aspects of the present disclosure can be implemented, in accordance with one or more embodiments of the present invention

FIG. 1B is a block diagram illustrating a schematic configuration of the modules in accordance with one or more embodiments of the present invention

FIG. 2 is an exemplary configuration of the autonomous knowledge-based smart waste collection system in accordance with another embodiment of the present invention

FIG. 3 is a schematic flow diagram illustrating a method for monitoring and collecting waste from a plurality of waste bins of an area by forecasting waste generation and optimizing a dynamic waste collection route in accordance with an embodiment of the present invention.

### ELEMENT LIST

Smart waste collection system 100
A plurality of waste bins 105
One or more on-board truck sensors 110
Autonomous collection vehicle 115
Cloud server 120
A plurality of databases 125
A plurality of modules 130
Communication network 135
Waste prediction module 140
Bin selection module 145
Route optimization module 150
Autonomous navigation module 155

### DETAILED DESCRIPTION

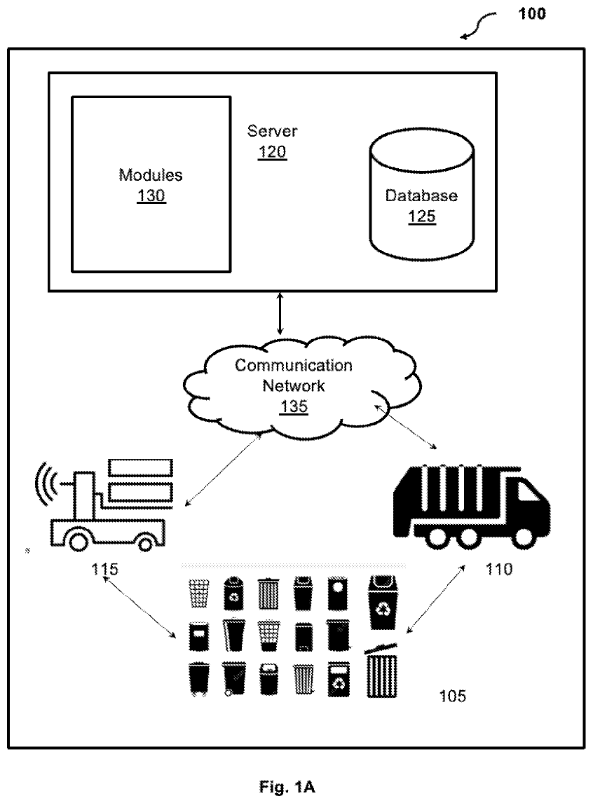

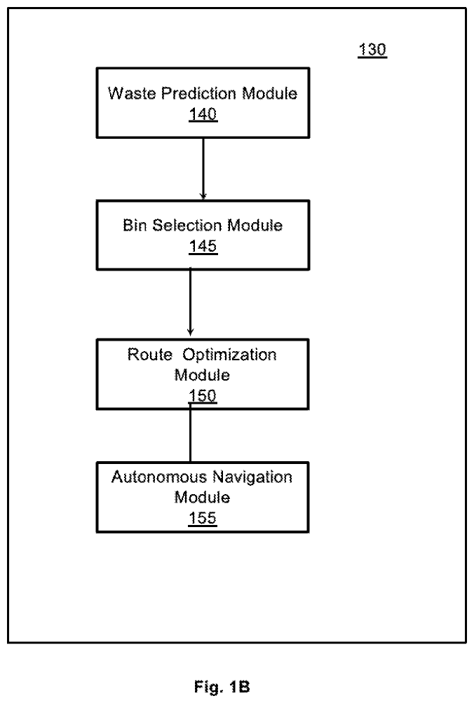

The present invention relates to an autonomous knowledge-based smart waste collection system for monitoring and collecting waste by forecasting waste generation patterns and optimizing waste collection routes. The principles of the present invention and their advantages are best understood by referring to FIG. 1A to FIG. 3. In the following detailed description of illustrative or exemplary embodiments of the disclosure, specific embodiments in which the disclosure may be practiced are described in sufficient detail to enable those skilled in the art to practice the disclosed embodiments.

The following detailed description is, therefore, not to be taken in a limiting sense, and the scope of the present disclosure is defined by the appended claims and equivalents thereof. References within the specification to “one embodiment,” “an embodiment,” “embodiments,” or “one or more embodiments” are intended to indicate that a particular feature, structure, or characteristic described in connection with the embodiment is included in at least one embodiment of the present disclosure.

Conventional waste collection (CWC) represents the conventional waste collection system in which all bins are serviced daily through the same route. Sensor-based smart waste collection (SWC) represents typical smart waste collection systems, employs weight sensors in waste bins to obtain the actual amount of waste. Knowledge-based waste collection (KWC) represents a proposed smart waste collection system for collecting solid waste of an area by forecasting waste generation and optimizing a waste collection route. Terms solid waste or waste or daily waste or rubbish or trash or refuse or litter or garbage may be used interchangeably throughout the application for convenience. Terms waste bin or one or more waste containers or trash cans may be used interchangeably throughout the application for convenience.

FIG. 1A is a block diagram illustrating an exemplary knowledge-based smart waste collection system within which various aspects of the present disclosure can be implemented, in accordance with one or more embodiments of the present invention. Referring to FIG. 1A, particularly the reference numbers denoting parts, FIG. 1A illustrates the smart waste collection system (100) monitoring and collecting solid waste of an area by predicting waste generation patterns and optimizing waste collection routes. The smart waste collection system (100) includes a plurality of waste bins (105), one or more on-board truck sensors (110), an autonomous collection vehicle (115), a cloud server (120), and a communication network (130). In particular, the cloud server (120) further includes a plurality of databases (hereinafter referred as database (125)) and a plurality of processing, modelling, decision-making, and control modules (135).

In accordance with an embodiment of the present invention, the smart waste collection system (100) is an autonomous knowledge-based smart waste collection system that optimizes waste collection routes and transmit the optimized dynamic routes to the waste collection vehicles based on the predicted volume of waste and enhances the utilization of waste collection vehicles by using less fuel for executing waste collection. The waste collection vehicles only collect the waste bin when the predicted volume of the waste is greater than the bin capacity thereby reducing unnecessary effort and resource utilization when collecting waste. Further, autonomous knowledge-based smart waste collection system receives real time updates of the waste collection vehicles and the road traffic conditions. Optionally, the autonomous knowledge-based smart waste collection system may classify and recycle different types of solid waste.

In accordance with an embodiment of the present invention, the waste bins (105) collect the waste of the area. And each of the plurality of waste bins (105) is associated with a unique number. The unique number is a unique identification code by which the waste bins (105) can be identified and located. Further, the unique identification code is also communicated via the communication network (135) to the server (120).

In accordance with an embodiment of the present invention, one or more on-board truck sensors (110) acquires waste generation data of the plurality of waste bins (105). The one or more on-board truck sensors (110) may include weighing sensors, level sensors, LiDAR sensors, cameras, spatial positioning sensors, and a combination thereof. In particular, the recorded waste generation data includes bins location, collection route, volume of daily waste collected, and alike data for each of the plurality of waste bins. The historical waste generation data may optionally include an indication of the nature of the waste, spatial position information pertaining to the plurality of waste bins (105) within the urban environment and temporal rate at which the waste bins are being filled with waste.

The autonomous collection vehicle (115) is configured to collect the waste from the plurality of waste bins (105) selected by the smart waste collection system. The autonomous collection vehicle (115) may be a GPS-navigated driverless collection truck or an autonomous electric mobile robot. As an example, at a certain point in time, it is determined that if a waste bin (105) is in need for collection, then the autonomous collection vehicle (115) receives a dynamic route to collect waste from that particular waste bin (105). The autonomous collection vehicle (115) is scheduled to service that particular waste bin (105). In an alternate embodiment, the autonomous collection vehicle (115) may be rerouted to service a particular waste bin that has reached at least 90% of total waste volume (its maximum capacity with a safety margin) and has been prioritized for service to comply with safety requirements and to avoid imposition of fines and penalties for being overfilled and/or their waste to reach a physical state that could represent a safety hazard (for example spread of disease and pests (for example rodents) arising from food wastes). Real-time traffic data may be used to avoid road closures, traffic accidents, road works, traffic congestion, and/or rush hours.

Optionally, the autonomous collection vehicle (115) is equipped with GPS, or similar position detection sensors, and wireless interfaces for providing in real time an indication of positions of the autonomous collection vehicle (115) to the cloud server (120), along with an indication of remaining waste holding capacity of the autonomous collection vehicle (115). The real time data provided may include but is not limited to an event of being delayed, or having a breakdown or needing repair, or having unexpectedly more waste collection capacity remaining, and so forth. Optionally, autonomous collection vehicle (115) may be specialized in handling certain types of waste, and their routes are computed as aforementioned on a basis of type that they are permitted to service for waste collection purposes.

The cloud server (120) is configured to receive one or more signals via the wireless communication network to forecast a dynamic waste collection route to collect the waste from the selected waste bin. The cloud server (120) may be, but not limited to a web server, an application server, a proxy server, a network server, or a server farm, and so forth. Embodiments of the present invention are intended to include or otherwise cover any type of the cloud server, including known, related art, and/or later developed technologies.

In some implementations, the cloud server (120) can communicate via a virtual private network (VPN), Secure Shell (SSH) tunnel, or other secure network connection. The database (125) is configured to store information communicated by the one or more on-board truck sensors (110) for the waste bins at the bin level. Moreover, the database (125) includes information regarding the patterns of the forecasted volume of waste predicted for each of the plurality of waste bins. The database (125) may further include a waste bin database, an autonomous vehicle database, a prediction pattern database, an authentication database, a dynamic route database, temporal patterns database, and the like. The plurality of modules (130) includes a waste prediction module (140), a bin selection module (145), a route optimization module (150), and an autonomous navigation module (155).

In accordance with an embodiment of the present invention, the communication network (135) is configured to allow communication between one or more on-board truck sensors (105), modules (130), database (125), cloud server (120), and autonomous collection vehicle (115). The communication network (135) may be any communication network, such as, but not limited to, the Internet, wireless networks, local area networks, wide area networks, private networks, a cellular communication network, corporate networks having one or more wireless access points or a combination thereof connecting any number of mobile clients, fixed clients, and servers and so forth. Examples of communication network (135) may include the Internet, a WIFI connection, a Bluetooth connection, a Zigbee connection, a communication network, a wireless communication network, a 3G communication network, a 4G communication network, a 5G communication network, a USB connection, or any combination thereof any transceiver, or any combination thereof by triangulation, by a local positioning (LPS) device, by a global positioning system (GPS), or by any combination thereof. In addition, short-range communication may occur, such as using Bluetooth, Wi-Fi, a radio-frequency transceiver, or other such transceivers.

In accordance with an embodiment of the present invention, the communication network (135) is a centralized blockchain network or a decentralized blockchain network. In some implementations, the smart waste collection system may be a distributed client/server system that spans one or more communication networks (not shown). It is understood that the models and modules are fine-tuned based on the actual quantity of generated waste measured through the on-board weighing system. In accordance with embodiments of the present invention, the smart waste collection system (100) may be configured with other smart city systems (previously developed or developing in future).

FIG. 1B is a block diagram illustrating a schematic configuration of the modules (130) in accordance with one or more embodiments of the present invention. The modules (130) include a waste prediction module (140), a bin selection module (145), a route optimization module (150), and an autonomous navigation module (155). The waste prediction module (140) is operably configured to forecast the volume of daily waste generated by a prediction model for each of the plurality of waste bins. The prediction model may constitute individual and/or hybrid supervised machine-learning models, including but not limited to, classification, regression, neural networks, ensemble, and/or hybrid algorithms, such as support vector machine, random forest, generalized linear model, and/or gradient boosted trees. Further, the waste prediction module (140) analyzes the historical waste generation data, the actual waste generation data, and the local parameters to forecast daily waste generation of each waste bin. In particular, the historical waste generation data includes bins location, collection route, weight and volume of daily waste collected, and alike data for each of the plurality of waste bins. Additionally, the local parameters include types of households, demographic statistics, seasonal calendar, temporal patterns such as holidays, festivals, and weather conditions, and/or other local data affecting waste generation patterns.

The bin selection module (145) is configured to prioritize and select one or more waste bin from the plurality of waste bins to be serviced for collecting waste by a bin selection algorithm. In particular, the bin selection algorithm prioritizes the waste bin to be serviced based on the forecasted waste quantity and selects the waste bin to be serviced for collection when the predicted volume of waste of the waste bin is larger than the capacity of the waste bin.

If the predicted volume of daily waste of the waste bin is less than the bin capacity, then the smart waste collection system skips the waste bin from the collection route and repeats the capacity check for the same bin on the next day and so on. In particular, the amount of waste in the waste bins that were not collected till it reaches the maximum capacity. In accordance with an embodiment of the present invention, the waste bin that has reached its maximum capacity with a safety margin to be collected waste.

The route optimization module (150) is configured to compute the optimized waste collection route for the waste bin to be serviced and transmit a real time traffic data thereof. In particular, the route optimization module (150) provides location of the selected waste bins on streets along with their latitude and longitude coordinates. Moreover, the route optimization module (150) simulates all the possible routes between the selected waste bins and then selects the route with the minimum length/distance. Further, the route optimization module (150) performs route optimization every day for the selected waste bins as the selected bins may change daily depending on the variation in the waste generation. In accordance with an embodiment of the present invention, the routes are simulated based on an optimization algorithm which determines the optimized route with the shortest path, least travel time, or maximum environmental and/or financial sustainability. The route optimization module may constitute individual and/or hybrid models based on exact optimization algorithms, such as integer programming and/or Dijkstra, and/or metaheuristic optimization methods, such as genetic algorithm, simulated annealing, particle swarm, and/or ant colony.

The autonomous navigation module (155) is operably configured to simulate with the route optimization module to transmit the optimized collection route for the waste bin to be serviced to an autonomous collection vehicle (115).

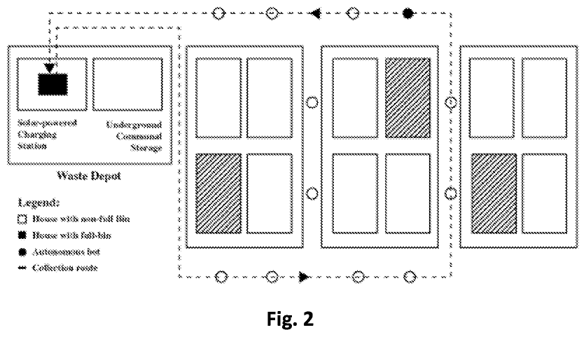

FIG. 2 is an exemplary configuration of the autonomous knowledge-based smart waste collection system in accordance with another embodiment of the present invention. The autonomous knowledge-based smart waste collection system is a cloud knowledge-based smart waste collection system with an autonomous electric-powered mobile robot following an optimum route to collect waste from the waste bins requiring service based on forecasted waste volumes. In particular, the autonomous electric-powered mobile robot has embedded sensors to record the actual collected waste for improved predictions in future. Moreover, the autonomous mobile robot can be a solar-powered autonomous mobile robot. The autonomous mobile robot returns to the solar- or electric powered charging station located in a communal waste depot and empties the collected waste into an underground storage container. A waste collection truck is dispatched to empty or replace the full container.

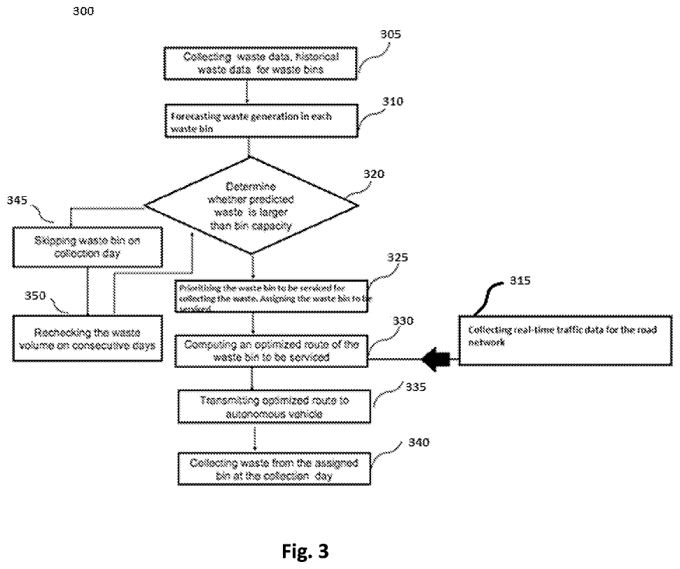

FIG. 3 is a schematic flow diagram illustrating a method to select and prioritize a waste bin in accordance with an embodiment of the present invention. In particular, the bin selection module selects and prioritizes using a bin-selection algorithm. The method 300 starts at step 305 and proceeds to step 310-340. At step 305, the actual waste generation data, historical waste generation data of the daily waste at a bin level for the plurality of waste bins (105) is collected by one or more on-board truck sensors (110). At step 310, actual waste generation data, historical waste generation data, and local parameters for the plurality of waste bins (105) are processed and used to forecast a volume of daily waste generated in each of the plurality of waste bins (105) by a waste prediction module (140). At step 325, the waste bin from the plurality of waste bins (105) to be serviced for collecting the waste is prioritized by a bin selection module (145). In particular, the waste bin that reaches the maximum capacity with a safety margin is prioritized for service. At step 320, a determination is made whether the volume of daily waste of the waste bin predicted is larger than the bin capacity of the waste bin by the bin selection module (145).

In one embodiment, when the determination is “YES” and the predicted waste volume is larger than the bin capacity of the waste bin. Then the method proceeds to step 325. In another embodiment, when the determination is “NO” and the predicted waste volume is not larger than the bin capacity of the waste bin, then the method proceeds to step 340.

At step 325, the waste bin to be serviced for collecting waste is further assigned by the bin selection module (145) to the route optimization module (150). At step 330, an optimized route is computed by the route optimization module (150) for the waste bin to be serviced. Step 315, where real-time traffic data for the road work is collected (and fed to the route optimization module)—is followed by step 330. The optimized route is computed along with the latitude and longitude coordinates of the waste bin to be serviced. Moreover, a different collection route is optimized every time depending on the waste bins to be serviced and the real-time traffic conditions of the road network. At step 335, the optimized route and the coordinates of the selected waste bins are transmitted by the autonomous navigation module (155) to the autonomous vehicle to collect the waste from the waste bins to be serviced. At step 340, the waste is collected by the autonomous vehicle from the waste bins to be serviced. At step 345, the waste bin having less waste volume is skipped from the collection route for that particular day. At step 350, the capacity check for the same waste bin is repeated on the next day and consecutive days. Step 345 proceeds to step 320 to check whether the predicted waste volume is larger than the bin capacity of the waste bin. Particularly, the waste bins that have reached their maximum capacity with a safety margin are selected.

The novel autonomous smart waste collection system of the present invention advantageously has the most efficient operation with maximum economic benefits and minimum environmental impacts. Moreover, it decreases the air pollution emissions from waste collection trucks, eliminates major capital and operating costs of the bin sensory data acquisition and communication system, offers a more cost-effective, eco-friendly, and offers shorter travel distances/times. It is understood by a person skilled in the art that the factors are not exhaustive, and the smart waste collection system can take into account fewer or more factors when performing its optimization computations.

In view of the foregoing, it will now be appreciated that the elements of the block diagram and flowcharts support combinations of means for carrying out the specified functions and processes, combinations of steps for performing the specified functions and processes, program instruction means for performing the specified functions and processes, and so on.

It will be appreciated that computer program instructions may include computer executable code. A variety of languages for expressing program instructions are possible, including without limitation C, C++, Java, JavaScript, assembly language, Lisp, HTML, Perl, and so on. Such languages may include assembly languages, hardware description languages, database programming languages, functional programming languages, imperative programming languages, and so on. Without limitation, embodiments of the system as described herein can take the form of web-based computer software, which includes client/server software, software-as-a-service, peer-to-peer software, or the like.

The functions, systems and methods herein described could be utilized and presented in a multitude of languages. Individual systems may be presented in one or more languages and the language may be changed with ease at any point in the process or method described above. One of the ordinary skills in the art would be to appreciate that there are numerous languages the system could be provided in, and embodiments of the present disclosure are contemplated for use with any language. The invention is capable of myriad modifications in various obvious aspects, all without departing from the spirit and scope of the present disclosure. Accordingly, the drawings and descriptions are to be regarded as illustrative in nature and not restrictive.

The features described herein may be combined to form additional embodiments and sub-elements of certain embodiments may form yet further embodiments. The foregoing summary of the present disclosure with the preferred embodiment should not be construed to limit the scope of the invention. It should be understood and obvious to one skilled in the art that the embodiments of the invention thus described may be further modified without departing from the spirit and scope of the invention.

1. A smart waste collection system for monitoring and collecting waste of an area by forecasting waste generation and optimizing a dynamic waste collection route comprising:
a plurality of waste bins for receiving waste of the area; each of the plurality of waste bins is associated with a unique identification number;
at least one on-board truck sensor for acquiring a waste generation data of the plurality of waste bins;
a waste prediction module for analyzing actual and historical waste generation data, wherein local parameters are used for the plurality of waste bins to forecast a volume of daily waste generated in each of the plurality of waste bins;
an autonomous collection vehicle for collecting waste from the plurality of waste bins therefrom; and
a cloud server for receiving one or more signals via a communication network to optimize the dynamic waste collection route;
wherein the cloud server comprises:
a plurality of databases to store data of the plurality of waste bins,
a plurality of modules, characterized in that a waste prediction module is operably configured to forecast waste generation patterns by a prediction model for each of the plurality of waste bins.

2. The smart waste collection system as claimed in claim 1,
wherein the cloud server further comprises a bin selection module configured to prioritize the waste bin from the plurality of waste bins to be serviced for collecting waste by a bin selection algorithm based on the actual waste quantity and forecasted waste quantity;
a route optimization module configured to compute and optimize the dynamic waste collection route for the waste bin to be serviced and transmit an optimized waste collection route thereof; an autonomous navigation module operably configured with the route optimization module to transmit the dynamic waste collection route for the waste bin to be serviced to the autonomous collection vehicle;
wherein the communication network allows communication between the one or more on-board truck sensors, the plurality of modules, the plurality of databases, the cloud server, and the autonomous collection vehicle,
and wherein the smart waste collection system is an autonomous knowledge-based smart waste collection system.

3. The smart waste collection system as claimed in claim 1, wherein the cloud server is configured to:
predict the volume of daily waste generated in each of the plurality of waste bins;
prioritize the waste bin from the plurality of waste bins to be serviced for collecting the waste; feed the waste bin to be serviced along with real-time traffic data to the route optimization module for computing the dynamic collection route for collecting waste;
assign the waste bin to be serviced for collecting waste to the autonomous vehicle; and
transmit the dynamic collection route with latitude and longitude coordinates of the waste bin; wherein a different dynamic waste collection route is optimized depending on the waste bins to be serviced.

4. The smart waste collection system as claimed in claim 1, wherein the at least one on-board truck sensors comprises at least one of a weighing sensor, a level sensor, a LiDAR sensor, a camera, a spatial positioning sensor, and a combination thereof.

5. The smart waste collection system as claimed in claim 1, wherein the historical waste generation data includes comprises an indication of a nature of the waste, spatial position information pertaining to the plurality of waste bins within an urban environment and a temporal rate at which the waste bins are being filled with waste for each of the plurality of waste bins.

6. The smart waste collection system as claimed in claim 1, wherein the prediction model constitutes different types of machine-learning algorithms, such as, classification, regression, neural networks, ensemble, or hybrid models, such as support vector machine, random forest, generalized linear model, and/or gradient boosted trees.

7. The smart waste collection system as claimed in claim 1, wherein the local parameters comprise types of households, demographic statistics, seasonal calendar, and other local data affecting waste generation patterns.

8. The smart waste collection system as claimed in claim 1, wherein the bin-selection algorithm selects one or more waste bin for service when the volume of daily waste of the waste bin predicted is larger than the capacity of the waste bin.

9. The smart waste collection system as claimed in claim 8, wherein the waste bin that has reached its maximum capacity with a safety margin is prioritized for service.

10. The smart waste collection system as claimed in claim 1, wherein the route optimization module is further configured to optimize the shortest route for the waste bins to be serviced.

11. The route optimization module as claimed in claim 10, wherein real-time traffic data of the road network is used to avoid road closures, traffic accidents, road works, traffic congestion, and/or rush hours.

12. The smart waste collection system as claimed in claim 1, wherein the route optimization module may constitute individual and/or hybrid models based on exact optimization algorithms, such as integer programming and/or Dijkstra, and/or metaheuristic optimization methods, such as genetic algorithm, simulated annealing, particle swarm, and/or ant colony.

13. The smart waste collection system as claimed in claim 1, wherein the smart waste collection system is operably configured with any smart transportation system and/or internet of things (IOT) systems in smart cities.

14. The smart waste collection system as claimed in claim 1, wherein the autonomous collection vehicle is a GPS-navigated autonomous collection truck or an autonomous electric mobile robot.

15. A method for monitoring and collecting waste from a plurality of waste bins of an area by forecasting waste generation and optimizing a dynamic waste collection route, wherein the method comprising the steps of:
collecting, by one or more on-board truck sensors an actual waste generation data which comprises an actual waste quantity and forecasted waste quantity along with a historical waste generation data of the plurality of waste bins;
analyzing, by a waste prediction module, the actual and historical waste generation data, and using local parameters for the plurality of waste bins to forecast a volume of daily waste generated in each of the plurality of waste bins;
prioritizing, by a bin selection module, the waste bin from the plurality of waste bins to be serviced for collecting the waste; the waste bin that has reached its maximum capacity with a safety margin is prioritized for service;
determining, by the bin selection module using a bin selection algorithm whether a volume of daily waste of the waste bin predicted is larger than bin capacity of the waste bin;
assigning, by the bin selection module, the waste bin to be serviced to a route optimization module only when the volume of daily waste of the waste bin predicted is larger than bin capacity of the waste bin;
computing and optimizing, by a route optimization module, the dynamic waste collection route with latitude and longitude coordinates of the waste bin to be serviced;
wherein a different dynamic waste collection route is optimized depending on the waste bins to be serviced and the real-time traffic data of the road network;
transmitting, by an autonomous navigation module, the optimized route to the autonomous vehicle to collect the waste from the waste bins to be serviced.

16. The method as claimed in claim 15, wherein a bin-selection algorithm selects one or more waste bin for service when volume of daily waste of the waste bin predicted is larger than bin capacity of the waste bin.

17. The method as claimed in claim 15, wherein the historical waste generation data includes bins location, collection route, volume of daily waste collected for each of the plurality of waste bins.

18. The method as claimed in claim 15, wherein the local parameters includes types of households, demographic statistics, seasonal calendar, and other local data affecting waste generation patterns.

19. The method as claimed in claim 15, wherein the waste prediction module forecasts the volume of daily waste generated using a prediction model based on a compatible individual and/or hybrid supervised machine-learning algorithm.

20. The method as claimed in claim 15, wherein the one or more on-board truck sensors includes at least one of a weighing sensor, a level sensor, a LiDAR sensor, a camera, a spatial positioning sensor and a combination thereof.
